(19) United States
(12) Patent Application Publication
(10) Pub. No.: US 2003/0037657 A1
(43) Pub. Date: Feb. 27, 2003

(54) Puncher for decorative sheet

(75) Inventors: Wan-Young Oh, Kangsu-gu (KR); .Ok-Hwan Kim, Kangsu-gu (KR)

Correspondence Address: BROWDY AND NEIMARK, P.L.L.C., 624 NINTH STREET, NW, SUITE 300, WASHINGTON, DC, 20001-5303, US

(73) Assignee: DN Craft Corporation, Songpa-gu (KR)

(21) Appl. No.: 09/932,996

(22) Filed: Aug. 21, 2001

(51) Int. Cl. B26D 5/08

(52) U.S. Cl. 83/620; 83/588

(57) ABSTRACT

A puncher for decorative sheet adapted to cut and punch margin or certain portions including the margins of paper sheet in various shapes to give decorative and beautiful effect to the paper is disclosed. The puncher have a stop protrusion formed at a rear portion of a base plate for limiting rearward movement of a sheet, and positioning markers for maintaining even spacing between the adjacent cut shapes formed at the sheet.

### BACKGROUND OF THE INVENTION

1. Field of the Invention

The present invention relates to a puncher for decorative sheet, and, more particularly to a puncher for decorative sheet adapted to cut and punch edges or certain portions including the edges of such paper sheets as photographs, cards, letters or the like in various shapes to give decorative and beautiful effect to the papers.

2. Description of the Prior Art

In general, a usual puncher for decorative sheet has a base plate that is formed at its center with a decorative punching hole. The base plate is integrally formed at its one side with a punch holder with a spacing therebetween. The punch holder is provided at its center with a holder hole having the same cross-sectional shape as that of the decorative punching hole. A spring is inserted over the punch holder so that a decorative punch having the same cross-sectional shape as that of the holder hole is elastically supported at the holder hole of the punch holder. The punch holder is integrally formed at its upper end with a pusher plate. The pusher plate has a push button inserted in a push button hole. A housing containing the pusher plate inserted in the push button hole is attached to the punch holder.

The conventional puncher is designed to cut or punch a marginal portion, i.e., a portion spaced from an edge of an objective sheet in various shapes to give esthetic appearance to the sheet, as shown in FIG. 7.

Though the puncher constructed as explained above is capable of punching a plurality of decorative holes repeatedly, spacing between the adjacent decorative holes is likely to be irregular, thereby causing the aesthetic appearance of the cut sheet to be poor. Furthermore, since a sheet to be punched such as a photograph, a card, a letter or the like is apt to be incorrectly positioned on the base plate, spacing between the adjacent decorative holes becomes irregular eventually even though the spacing is adjusted constantly.

### SUMMARY OF THE INVENTION

Accordingly, the present invention has been made keeping in mind the above problems occurring in the prior art, and an object of the present invention is to provide a puncher for decorative sheet capable of punching an marginal area (a corner portion or an edge portion) of paper sheets such as photographs, cards, letters or the like in a predetermined shape while correctly positioning the sheet and maintaining even spacing between the adjacent cut hole shapes formed at the sheet.

In order to accomplish the above object, the present invention provides a puncher for decorative sheet comprising: a housing having a space therein, from which a pusher member is partially protruded upward; a cutting member having a flat head plate and first and a second cutter blades attached to a lower surface of the head plate for punching a sheet in a predetermined shape; an elastic member for restoring the cutting member pushed by the pusher member into the original position; a jig including a guide plate having guide holes having the same shapes as those of cross-sections of the first and second cutter blades and a punching plate having punching holes having the same shapes as those of the guide holes and a gripping slit therein; and a base plate including a sheet-supporting plate having a through hole for holding the jig and discarding the cut sheet scraps therethrough, the sheet-supporting plate being provided at its rear portion with a stop protrusion for limiting a rearward movement of the sheet and being provided with positioning markers for maintaining even spacing between adjacent cut shapes of the sheet.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing a puncher for decorative sheet embodying the present invention;

FIG. 2 is an exploded perspective view of the puncher;

FIG. 3 is a cross-sectional view showing assembled state of the puncher;

FIG. 4 is a side cross-sectional view showing the puncher, in which a housing is removed;

FIG. 5a is a cross-sectional view showing the puncher before a punching operation;

FIG. 5b is a view similar to FIG. 5a, showing the puncher after a punching operation;

FIG. 6 is a schematic view showing a sheet cut by the puncher according to the invention; and

FIG. 7 is a schematic view showing a sheet cut by a conventional puncher.

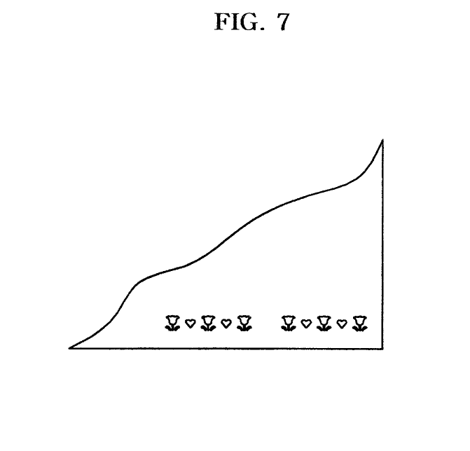

### DETAILED DESCRIPTION OF THE INVENTION

Reference now should be made to the drawings, in which the same reference numerals are used throughout the different drawings to designate the same or similar components.

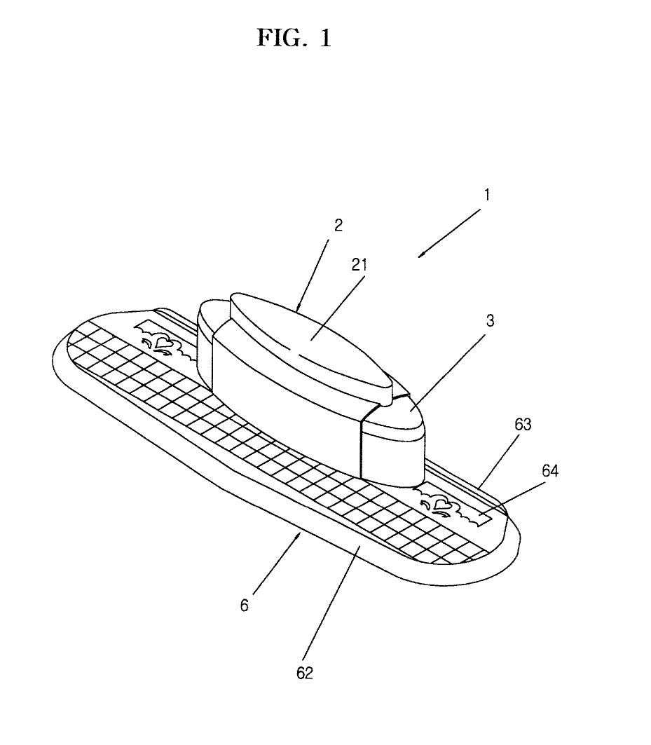

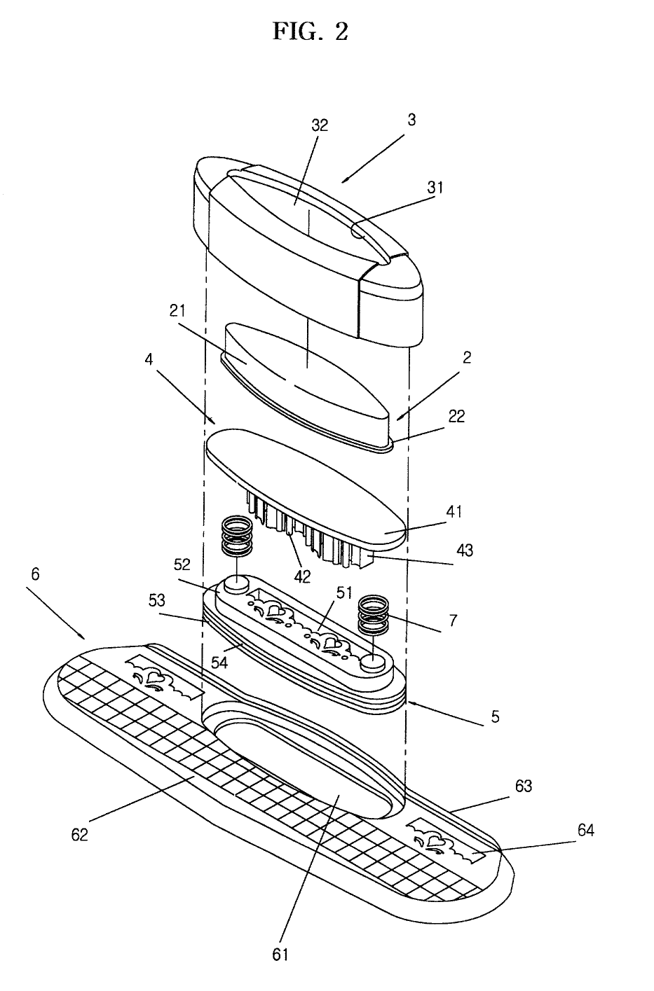

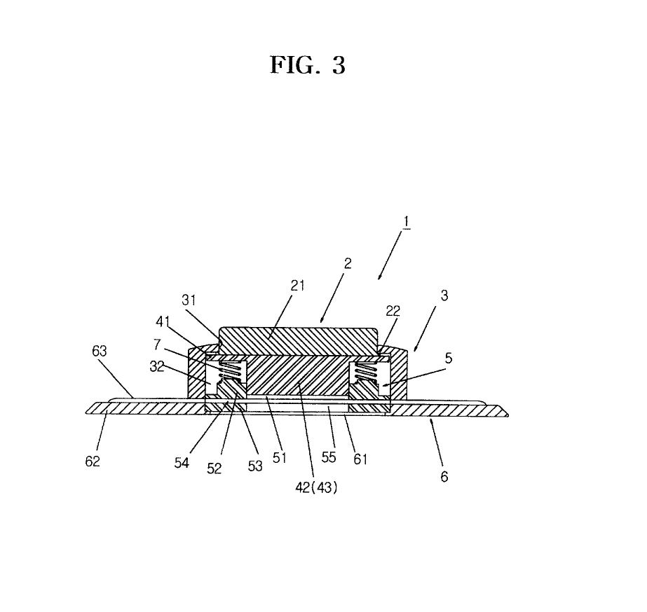

FIG. 1 is a perspective view showing a puncher for decorative sheet according to the present invention, FIG. 2 is an exploded perspective view, and FIG. 3 is a cross-sectional view.

As illustrated in the drawings, the puncher 1 for decorative sheet according to the present invention comprises a pusher member 2, a housing 3, a cutting member, a jig 5 and a base plate 6.

The housing 3 is formed at its center portion with a through hole 31 such that the pusher member 2 is partially protruded upward, and has a space 32 therein.

The pusher member 2 includes a pushing portion 21 passed through the through hole 31 and a flange 22 integrally formed at a periphery of its lower end for preventing the pusher member 2 from being withdrawn from the housing 3.

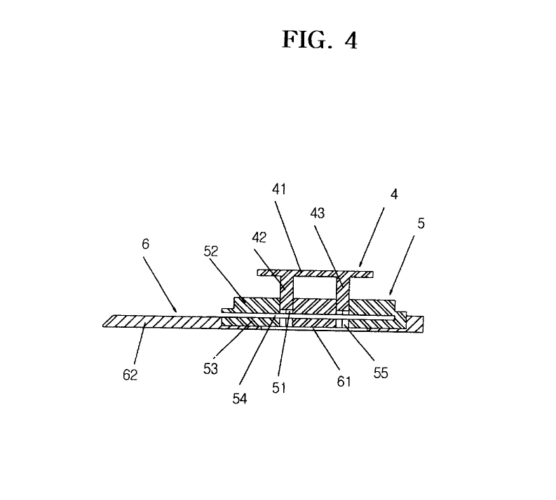

The space 32 of the housing 3 receives the cutting member 4 therein. The cutting member 4 has a head plate 41 placed at its uppermost portion, a first cutter blade 42 formed at a lower surface of the head plate 41, which is adapted to cut a sheet such as a paper sheet in a predetermined shape, and a second cutter blade 43 for cutting a peripheral portion of the shape, as shown in FIGS. 2 and FIG. 4.

The jig 5 adapted to be mated to the cutting member 4 includes a guide plate 52 having guide holes 51 corresponding the first and second cutter blades 42 and 43 therein, and a punching plate 53 having punching holes 55 adjacent to the guide holes 51 and having a gripping slit 54 adapted to separate the punching plate 53 into two sub punching plate with a joining portion therebetween, as shown in FIGS. 2 and 4. Between the jig 5 and the cutting member 4 is displaced at its both sides an elastic member 7 for restoring the cutting member 4 pushed by the pusher member 2 to the original position.

The base plate 6 includes a sheet-supporting plate 62 having a through hole 61 for holding the jig 5 therein and discarding paper scraps resulting from the punching operation. The sheet-supporting plate 62 is provided at its rear edge with a stop protrusion 63 protruded upward. The sheet-supporting plate 62 is formed at its upper surface with positioning markers 64 for allowing the punched shapes to have n even predetermined spacing, and to be checked by user during continuous punching operation.

The positioning markers 64 are positioned at both sides with regard to the jig 5. The sheet-supporting plate 62 is provided at its upper surface, except the rear side at which the stop protrusion 63 is positioned, with an inclined plane for preventing the sheet from being lifted during gripping of the sheet.

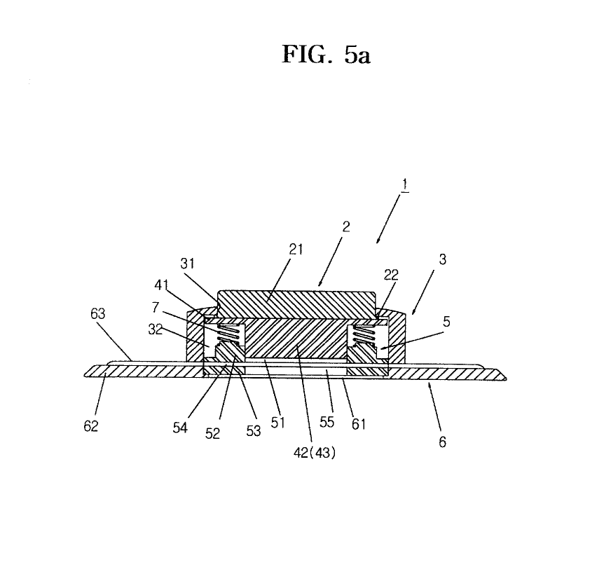

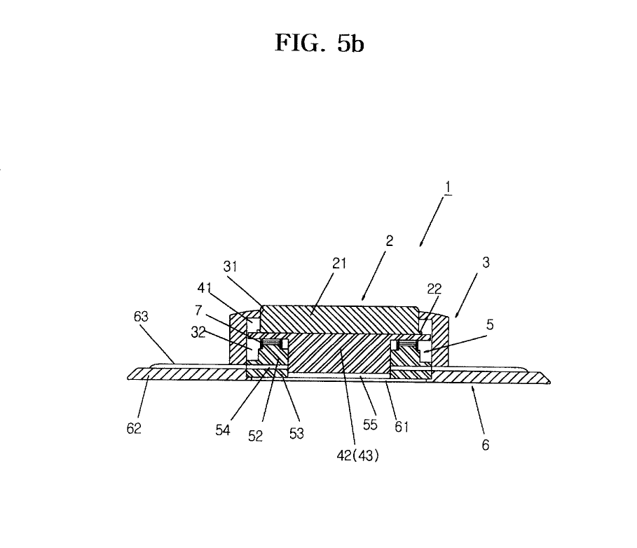

In an operation of the puncher for decorative sheet according to the invention constructed as illustrated above, a sheet to be punched is first inserted into the gripping slit 54 and then the inserting movement of the sheet is stopped by the stop protrusion 63, thereby causing a side of the sheet to be positioned to be parallel to the stop protrusion 63, as shown in FIG. 5a.

When the sheet to be punched is correctly positioned by the stop protrusion 63, the sheet is held by being pushed by one hand of a user. At this point, the corrugation of the sheet is prevented because the base plate 6 is provided at its front side with the inclined plane.

When the sheet is correctly positioned, the pusher member 2 is pushed downward, as shown in FIG. 5b. The head plate 41 of the cutting member 4 having same shape as that of the lower surface of the pusher member 2 is moved downward while compressing the elastic member 7. At this point, the first cutter blade 42 and the second cutter blade 43 attached to the lower surface of the head plate 41 are also moved downward.

The first cutter blade 42 and the second cutter blade 43 of the cutting member 4, which are moved by the pusher member 2, are inserted into the guide holes 51 having the same shapes as those of cross-sections of the first cutter blade 42 and the second cutter blade 43, and thus are guided by the guide holes 51, thereby preventing the first cutter blade 42 and the second cutter blade 43 from being displaced.

The first and second cutter blades 42 and 43, which are passed through the guide holes 51 of the guide plate 52, press the sheet inserted in the gripping slit 54 downward and then enter the punching holes 55 of the punching plate 53.

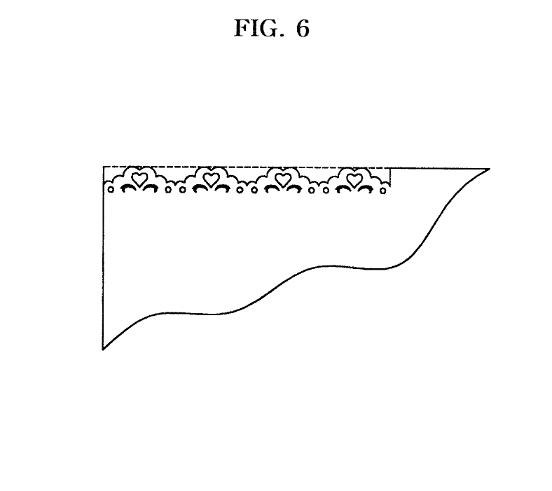

Therefore, the objective sheet is punched at its edge or the portion including the edge in certain shapes, as shown in FIG. 6, and the marginal portion (a corner portion or an edge portion) is cut in the shape corresponding to those of the first and second cutter blades 42 and 43.

The sheet scraps resulting from the punching are easily discharged into the through hole 61. When the above-mentioned cutting operation for forming marginal portions (a corner portion or an edge portion) by the punched portions is continuously carried out, the previously punched shape has to be equal to that of a shape to be punched.

When the punching and cutting operation is carried out repeatedly, the cut hole shape formed at the marginal area of the sheet must be coincide with the positioning marker 64 formed at both sides with regard to the jig 5 so that a spacing between the adjacent cut shapes is constant.

As described above, the present invention provides a puncher for decorative sheet capable of decoratively punching sheets such paper sheets, photographs, cards, letters or the like in a predetermined shape to allow the marginal area of the sheet to have decorative design while correctly positioning the sheet and maintaining even spacing between the adjacent cut shapes formed at the sheet.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A puncher for decorative sheet comprising:
a housing having a space therein, from which a pusher member is partially protruded upward;
a cutting member having a flat head plate and first and second cutter blades attached to a lower surface of the head plate for punching a sheet in a predetermined shape;
an elastic member for restoring the cutting member pushed by the pusher member into the original position;
a jig including a guide plate having guide holes having the same shapes as those of cross-sections of the first and second cutter blades and a punching plate having punching holes having the same shapes as those of the guide holes and a gripping slit therein; and
a base plate including a sheet-supporting plate having a through hole for holding the jig and discarding the cut sheet scraps therethrough, the sheet-supporting plate being provided at its rear portion with a stop protrusion for limiting a rearward movement of the sheet and being provided with positioning markers for maintaining an even spacing between adjacent cut shapes of the sheet.

2. The puncher for decorative sheet as set forth in claim 1, in which the positioning markers are displaced at both sides with regard to the jig.

3. The puncher for decorative sheet as set forth in claim 1, in which the upper surface of the base plate is provided at its front area, except the rear area at which the stop protrusion is formed, with an inclined plane for preventing the sheet from being lifted.
